(19) United States
(12) Patent Application Publication
(10) Pub. No.: US 2023/0271570 A1
(43) Pub. Date: Aug. 31, 2023

(54) WIRE HARNESS

(71) Applicant: SUMITOMO WIRING SYSTEMS, LTD., Yokkaichi-shi (JP)

(72) Inventor: Yuya HIROMORI, Yokkaichi-shi (JP)

(73) Assignee: SUMITOMO WIRING SYSTEMS, LTD., Yokkaichi-shi (JP)

(21) Appl. No.: 18/166,821

(22) Filed: Feb. 9, 2023

(30) Foreign Application Priority Data
Feb. 25, 2022 (JP) 2022-027733

(51) Int. Cl. B60R 16/02; H01B 7/20; H02G 3/04

(52) U.S. Cl. CPC B60R 16/0215; H01B 7/20; H02G 3/0481

(57) ABSTRACT

A wire harness including: an electrical wire including a core wire and an insulating cover that covers an outer circumference of the core wire; a pipe that covers the electrical wire; and a holder that holds the electrical wire and is fixed to an end of the pipe in a length direction, wherein: the insulating cover includes a recess formed in an outer circumferential surface of the electrical wire, and the holder includes a catch that restricts movement of the electrical wire in a length direction of the electrical wire relative to the holder by the catch fitting into the recess.

### BACKGROUND

The present disclosure relates to a wire harness.

A known wire harness is provided with an electrical wire, a pipe that covers the outer circumference of the electrical wire, and a holder that holds the electrical wire and is fixed to an end portion of the pipe in the length direction (see JP 2017-84547A, for example). The holder includes a cylindrical internal fitting portion that is fitted inside the end portion of the pipe in the length direction and a holding piece that extends from a portion in the circumferential direction of the internal fitting portion inside the pipe. The holder holds the electrical wire by the holding piece being wrapped around with adhesive tape together with the electrical wire. With such a wire harness, the position of the electrical wire relative to the end portion of the pipe is maintained by the holder, and thus rubbing of the electrical wire against the end portion of the pipe is suppressed, for example.

### SUMMARY

However, with the wire harness described above, adhesive tape is needed for the electrical wire to be held in the holder. Accordingly, inside the pipe, there needs to be space for housing the electrical wire, the holding piece, and the adhesive tape, and thus the diameter of the pipe needs to be increased, for example. Also, using adhesive tape means that the number of parts is increased and that a tape wrapping operation is required.

An exemplary aspect of the disclosure provides a wire harness that enables an electrical wire to be held without using adhesive tape.

A wire harness according to the present disclosure includes an electrical wire including a core wire and an insulating cover that covers an outer circumference of the core wire; a pipe that covers the electrical wire; and a holder that holds the electrical wire and is fixed to an end of the pipe in a length direction, wherein the insulating cover includes a recess formed in an outer circumferential surface of the electrical wire, and the holder includes a catch that restricts movement of the electrical wire in a length direction of the electrical wire relative to the holder by the catch fitting into the recess.

According to a wire harness of the present disclosure, an electrical wire can be held without using adhesive tape.

### BRIEF DESCRIPTION OF THE DRAWINGS

FIG. 1 is a schematic configuration diagram of a wire harness according to an embodiment.

FIG. 2 is a partial cross-sectional view of a wire harness according to an embodiment.

FIG. 3 is a partial perspective view of a wire harness according to an embodiment.

FIG. 4 is a partial exploded perspective view of a wire harness according to an embodiment.

FIG. 5 is cross-sectional view taken along line 5-5 in FIG. 2.

### DETAILED DESCRIPTION OF EMBODIMENTS

### Description of Embodiments

Firstly, aspects of the present disclosure will be listed and described. A wire harness according to the present disclosure is

(1) A wire harness including an electrical wire including a core wire and an insulating cover that covers an outer circumference of the core wire; a pipe that covers the electrical wire; and a holder that holds the electrical wire and is fixed to an end portion of the pipe in a length direction, herein the insulating cover includes a recess portion formed in an outer circumferential surface of the electrical wire, and the holder includes a catch portion that restricts movement of the electrical wire in a length direction of the electrical wire relative to the holder by the catch portion fitting into the recess portion.

According to this configuration, the holder includes the catch portion that restricts the movement of the electrical wire in the length direction relative to the holder by being fitted into the recess portion of the insulating cover. Thus, the movement of the electrical wire 20 in the length direction is restricted without using adhesive tape. Also, the catch portion is configured to be fit into the recess portion formed in the insulating cover. Thus, space is not needed on the outer side of the insulating cover and housing space is not required to be ensured on the inside of the pipe. Accordingly, the diameter of the pipe can be made smaller compared to a configuration that uses adhesive tape, for example. Also, a tape wrapping operation or the like for the adhesive tape is also no required.

(2) Preferably, the catch portion also restricts movement of the electrical wire in a direction intersecting the length direction of the electrical wire relative to the holder when the catch portion is fitted into the recess portion. According to this configuration, the catch portion restricts the movement of the electrical wire in a direction intersecting the length direction relative to the holder when fitted into the recess portion. Thus, the movement of the electrical wire in a direction intersecting the length direction is also restricted without using adhesive tape.

(3) Preferably, the recess portion is one of a plurality of recess portions, and the plurality of recess portions are provided in the insulating cover at a plurality of different positions in the length direction of the electrical wire.

According to this configuration, the recess portions and the catch portions that fit into the recess portions are provided at a plurality of different positions in the length direction of the electrical wire. Thus, for example, compared to a configuration in which the recess portion and the catch portion are only provided at one position in the length direction of the electrical wire, the electrical wire can be firmly held.

(4) Preferably, the recess portion is formed from the outer circumferential surface of the electrical wire to the core wire. According to this configuration, the recess portion is formed from the outer circumferential surface of the electrical wire to the core wire. Thus, for example, compared to a configuration in which the recess portion is not formed to the core wire, the engagement area with the catch portion can be increased. Accordingly, the electrical wire can be firmly held.

(5) Preferably, the electrical wire is one of two electrical wires, the catch portion is one of a pair of catch portions located opposite one another in a radial direction of the holder, and the pair of catch portions are configured to sandwich the two electrical wires in a direction the two electrical wires are arranged.

According to this configuration, the pair of catch portions are configured to sandwich the two electrical wires in the direction the electrical wires are arranged. Thus, the two electrical wires can be well held.

### DETAILED DESCRIPTION OF EMBODIMENTS

A specific example of a wire harness according to the present disclosure will be described below with reference to the drawings. In the drawings, components of the configuration may be exaggerated or simplified for the sake of convenience. Also, the dimensions and proportions of the components may be different in each diagram. Note that the present disclosure is not limited to these examples and is defined by the scope of the claims, and intended to include all modifications that are equivalent to or within the scope of the claims. The terms “parallel” and “orthogonal” used in the present specification do not mean only strictly parallel and orthogonal and also include substantially parallel and orthogonal within a range in which the operation and effects of the present embodiment can be achieved. Also, the terms “circle” and “arc” used in the present specification do not mean only strictly a circle and arc and also include substantially a circle and arc within a range in which the operation and effects of the present embodiment can be achieved.

### Overall Configuration of Wire Harness 10

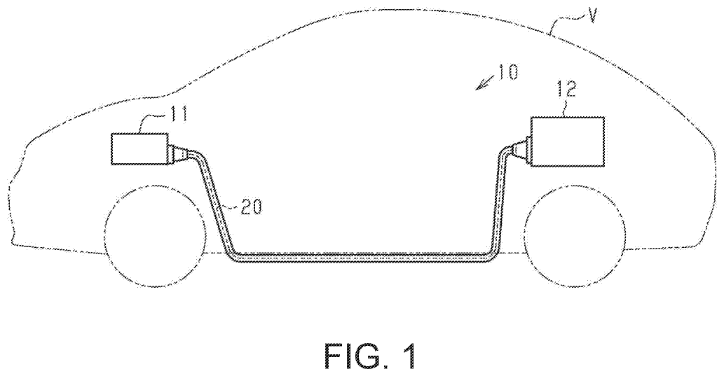

A wire harness 10 illustrated in FIG. 1, electrically connects two or three or more electric devices. The wire harness 10, for example, electrically connects an inverter 11 installed in a front portion of a vehicle V, such as a hybrid vehicle or an electric vehicle, and a high voltage battery 12 installed further to the rear of the vehicle than the inverter 11. The wire harness 10 is routed, for example, under the floor of the vehicle V. For example, the wire harness 10 is routed so that an intermediate portion of the wire harness 10 in the length direction travels outside the vehicle cabin, such as beneath of the floor of the vehicle V.

The inverter 11 is connected to a not-illustrated motor for driving a wheel which acts as the power source for driving the vehicle. The inverter 11 generates an alternating current from the direct current of the high voltage battery 12 and supplies the alternating current to the motor. The high voltage battery 12, for example, is a battery capable of supplying voltage of hundreds of volts.

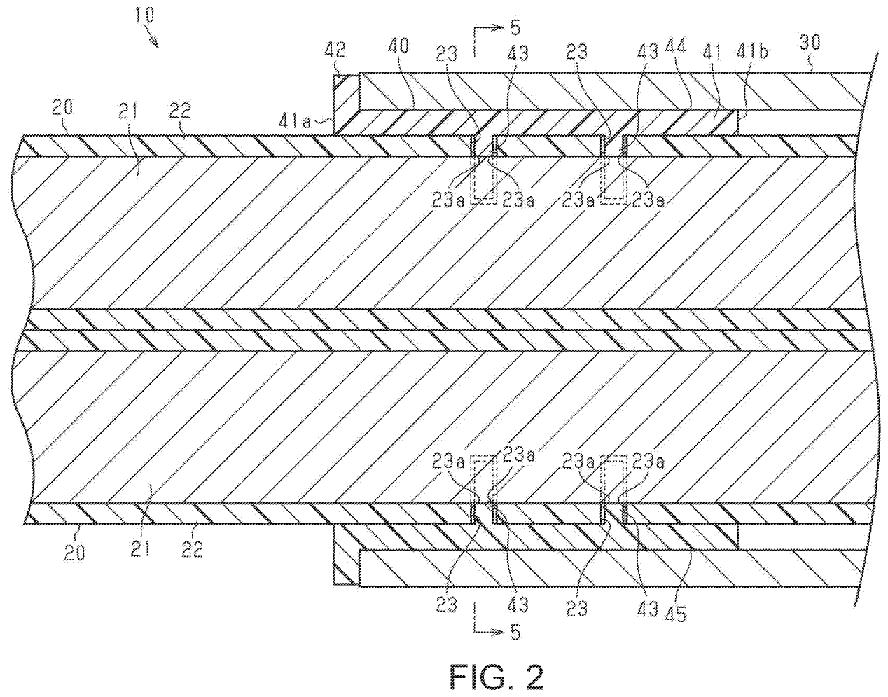

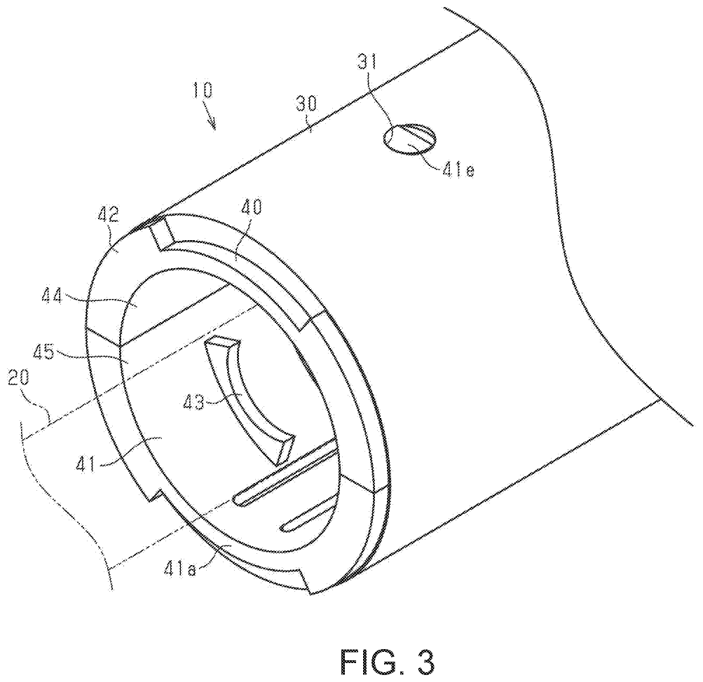

As illustrated in FIGS. 2 and 3, the wire harness 10 includes an electrical wire 20 that electrically connects the electric devices described above, a pipe 30 that covers the outer circumference of the electrical wire 20, and a holder 40 that is attached to an end portion of the pipe 30 in the length direction.

### Configuration of Electrical Wire Member 20

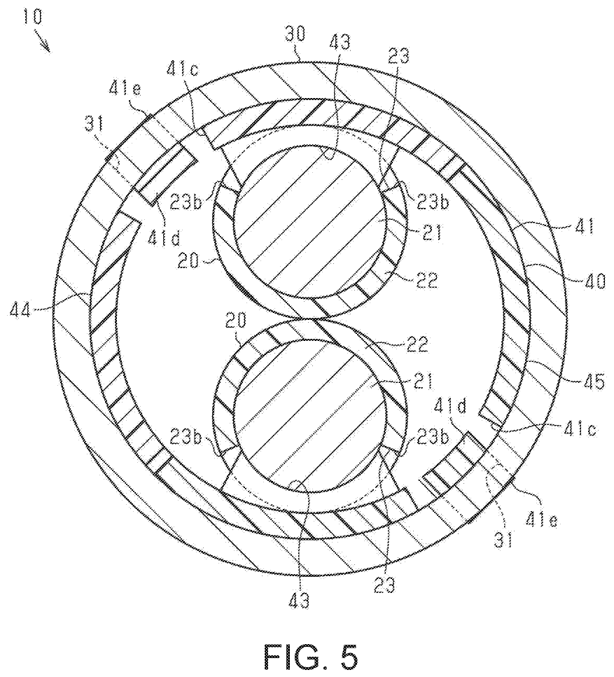

As illustrated in FIGS. 2 and 5, the electrical wire 20 includes a core wire 21 and an insulating cover 22 that covers the outer circumference of the core wire 21. The wire harness 10 of the present embodiment includes two electrical wires 20.

As the core wire 21, for example, a stranded wire including a plurality of individual metal wires twisted together or a braided member including a plurality of individual metal wires braided in a cylindrical shape may be used. The core wire 21 of the present embodiment is a stranded wire. A metal material, such as a copper-based material or an aluminum-based material may be used as the material of the core wire 21, for example. Note that in FIGS. 2 and 5, the core wire 21, i.e., the stranded wire, is schematically illustrated.

The insulating cover 22 covers the outer circumferential surface of the core wire 21 entirely in the circumferential direction. The insulating cover 22, for example, is formed by a synthetic resin insulating material or the like. The insulating cover 22 includes a recess portion 23 (recess) formed in the outer circumferential surface of the electrical wire 20. As illustrated in FIG. 5, the recess portion 23 is provided in a portion in the circumferential direction of the insulating cover 22. As illustrated in FIG. 2, two recess portions 23 are provided separated from one another in the length direction of the electrical wire 20. The recess portion 23 is formed from the outer circumferential surface of the electrical wire 20 to the core wire 21. The recess portion 23 is formed by removing a portion of the insulating cover 22. In this manner, the core wire 21 of the present embodiment is exposed at the portion corresponding to the recess portion 23 to the outside.

Configuration of Pipe 30

The pipe 30 is formed in an elongated cylindrical shape. The pipe 30 of the present embodiment is formed as a perfect circle cylinder. The pipe 30 internally houses an intermediate portion of the electrical wire 20 in the length direction, for example. The pipe covers the outer circumference of the electrical wire 20 entirely in the circumferential direction, for example. A metal pipe or a resin pipe may be used as the pipe 30, for example. A metal material, such as an aluminum-based material, a copper-based material, or the like may be used as the material for a metal pipe, for example. A synthetic resin, such as polyolefin, polyamide, polyester, or ABS resin, may be used as the material for a resin pipe, for example. The pipe 30 of the present embodiment is a metal pipe.

The pipe 30, for example, bend in a two-dimensional manner or a three-dimensional manner at a portion extending from under the floor of the vehicle V upward. For example, the process of bending the pipe 30 is performed with the electrical wire 20 inserted inside the pipe 30 in a straight state.

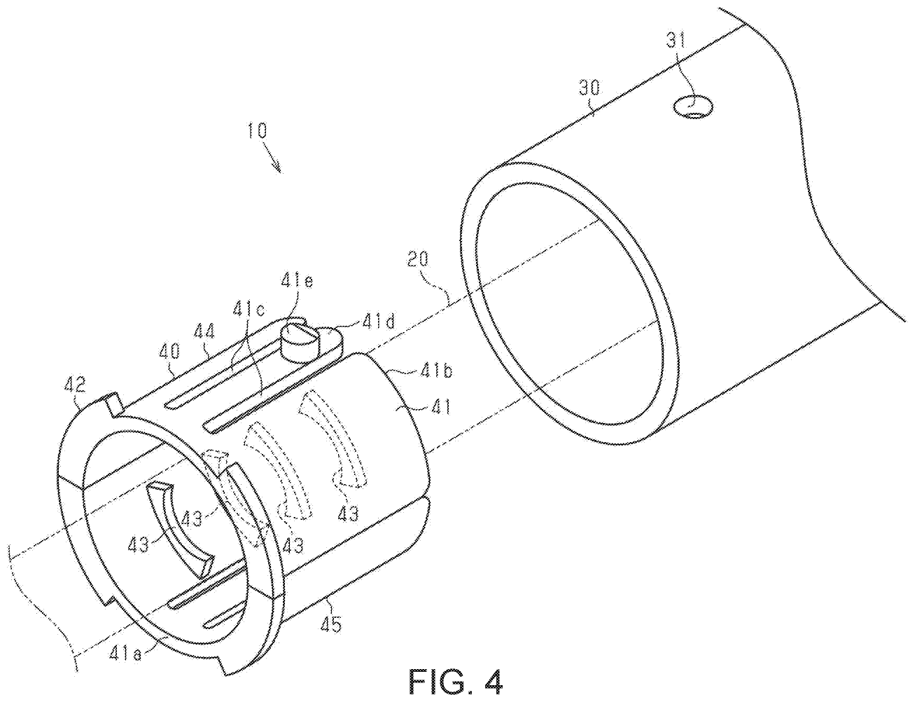

As illustrated in FIG. 4, the pipe 30 includes a circular through holes 31. The through holes 31 are provided at positions near the end portion of the pipe 30 in the length direction. The through holes 31 are provided at two locations in the circumferential direction of the pipe 30. The through holes 31 are provided at equal intervals in the circumferential direction of the pipe 30.

### Configuration of Holder 40

As illustrated in FIGS. 2 and 4, the holder 40 includes a cylindrical portion 41, a flange portion 42, and a catch portion 43 (catch). The cylindrical portion 41 is fitted into the end portion of the pipe 30 in the length direction. The outer circumferential surface of the cylindrical portion 41 faces the inner circumferential surface of the pipe 30. The flange portion 42 is provided on a first end portion 41a of the cylindrical portion 41 in the length direction. The flange portion 42 project radially outward from the cylindrical portion 41. The flange portion 42 is provided on a portion in the circumferential direction of the cylindrical portion 41. The flange portion 42 comes into contact with the end surface of the pipe 30 in the length direction when the cylindrical portion 41 is fitted into the pipe 30. The holder 40 is composed of a first component 44 and a second component 45 including the cylindrical portion 41 and the flange portion 42 divided in the circumferential direction. In other words, the cylindrical portion 41 is formed by joining together the end portions in the circumferential direction of the first component 44 and the second component 45 with semicircular arc-shaped cross-sections. The first component 44 and the second component are made of resin.

As illustrated in FIG. 4, the cylindrical portion 41 includes slits 41c extending from a second end portion 41b of the cylindrical portion 41 in the length direction toward the first end portion 41a side. The cylindrical portion 41 includes a flexible piece 41d between the pair of slits 41c. The flexible piece 41d can bend on the second end portion 41b side in the radial direction. As illustrated in FIG. 5, the flexible piece 41d is provided at two locations in the circumferential direction of the cylindrical portion 41. The flexible pieces 41d are provided at equal intervals in the circumferential direction of the cylindrical portion 41. The flexible pieces 41d are provided in the center of the first component 44 in the circumferential direction and in the center of the second component 45 in the circumferential direction.

The flexible piece 41d includes a fixing protrusion portion 41e. The fixing protrusion portion 41e projects radially outward from the cylindrical portion 41. As illustrated in FIGS. 4 and 5, the fixing protrusion portion 41e inhibits the cylindrical portion 41 from falling out from the pipe 30 by being fitted into the through hole 31 when the cylindrical portion 41 is fitted into the pipe 30. In this manner, the holder 40 is fixed to the pipe 30.

As illustrated in FIGS. 2 and 5, the catch portion 43 projects radially inward from the cylindrical portion 41. The catch portion 43 is configured to fit into the recess portion 23 of the insulating cover 22. In this manner, the catch portion 43 can engage with an end surface 23a of the recess portion 23 in the length direction of the electrical wire 20, thus restricting the movement of the electrical wire 20 in the length direction relative to the holder 40. Specifically, as illustrated in FIG. 5, the catch portion 43 is provided at a portion in the circumferential direction of the cylindrical portion 41. The catch portion 43 is provided in both the first component 44 and the second component 45 between the end portions in the circumferential direction and the flexible piece 41d. The pair of catch portions 43 are located opposite one another in the radial direction of the cylindrical portion 41. The catch portions 43, when fitted into the recess portions 23, are formed to a position where they come into contact with the outer circumferential surface of the core wire 21. The distal end of the catch portion 43 have an arc shape corresponding to the outer circumferential surface of the core wire 21. In this manner, the catch portions 43 are configured to also restrict the movement of the electrical wire 20 in a direction intersecting the length direction relative to the holder 40, when the catch portions 43 are fitted into the recess portions 23. In other words, the pair of catch portions 43 are configured to sandwich the two electrical wires 20 in the direction the electrical wires 20 are arranged and also restrict the movement of the electrical wires 20 in a direction intersecting the length direction by engaging with the outer circumferential surfaces of the core wires 21, when sandwiching the electrical wires 20. Also, in addition to the engagement between the pair of catch portions 43 and the outer circumferential surfaces of the core wires 21, because the pair of catch portions 43 can engage with end surfaces 23b of the recess portions 23 in the circumferential direction of the electrical wires 20, the movement of the electrical wires 20 in a direction intersecting the length direction can be restricted.

As illustrated in FIG. 2, the catch portions 43 are provided at two different positions in the length direction of the electrical wire 20 on the inner circumferential surface of the first component 44. In a similar manner, the catch portions 43 are provided at two different positions in the length direction of the electrical wire 20 also on the inner circumferential surface of the second component 45. In other words, in the present embodiment, the first component 44 and the second component 45 are both provided with two catch portions 43.

Next, the operation of the present embodiment will be described. The electrical wires 20 are held in the holder 40 by the catch portions 43 that fit into the recess portions 23 of the insulating covers 22. Also, the holder 40 is fixed to the end portion of the pipe 30 in the length direction by the fixing protrusion portion 41e that fits into the through hole 31. Accordingly, when a bending process is performed on the pipe 30, for example, even if force is applied to the electrical wires 20, the electrical wires 20 are inhibited from being moved out of position in the length direction relative to the end portion of the pipe 30. Also, for example, the electrical wires 20 rubbing against the end portion of the pipe 30 is suppressed.

Next, the effects of the embodiment described above will be listed below.

(1) The holder 40 includes the catch portions 43 that restrict the movement of the electrical wires 20 in the length direction relative to the holder 40 by being fitted into the recess portions 23 of the insulating covers 22. Thus, the movement of the electrical wires 20 in the length direction is restricted without using adhesive tape. Also, the catch portions 43 are configured to be fit into the recess portions 23 formed in the insulating covers 22. Thus, space is not needed on the outer side of the insulating covers 22 and housing space is not required to be ensured on the inside of the pipe 30. Accordingly, the diameter of the pipe 30 can be made smaller compared to a configuration that uses adhesive tape, for example. Also, a tape wrapping operation or the like for the adhesive tape is also not required.

(2) The catch portions 43 restrict the movement of the electrical wires 20 in a direction intersecting the length direction relative to the holder 40 when fitted into the recess portions 23. Thus, the movement of the electrical wires 20 in a direction intersecting the length direction is also restricted without using adhesive tape.

(3) The recess portions 23 and the catch portions 43 that fit into the recess portions 23 are provided at a plurality of different positions in the length direction of the electrical wires 20. Thus, for example, compared to a configuration in which the recess portion 23 and the catch portion 43 are only provided at one position in the length direction of the electrical wire 20, the electrical wires 20 can be firmly held.

(4) The recess portion 23 is formed from the outer circumferential surface of the electrical wire 20 to the core wire 21. Thus, for example, compared to a configuration in which the recess portion 23 is not formed to the core wire 21, the engagement area with the catch portion 43 can be increased. Accordingly, the electrical wires 20 can be firmly held.

(5) The holder 40 includes the pair of catch portions 43 located opposite one another in the radial direction of the holder 40. The pair of catch portions 43 are configured to sandwich the two electrical wires 20 in the direction the electrical wires 20 are arranged. Thus, the two electrical wires 20 can be well held.

The present embodiment can be implemented by making the following modifications. The present embodiment and the following modified examples can be implemented in any combination as long as no technical inconsistency arises.
In the embodiment described above, the distal end of the catch portion 43 has an arc shape corresponding to the outer circumferential surface of the core wire 21. This allows the catch portion 43 to also restrict the movement of the electrical wire 20 in a direction intersecting the length direction relative to the holder 40 when the catch portion 43 is fitted into the recess portion 23. However, no such limitation is intended. For example, the catch portion 43 may be provided around the entire circumference of the cylindrical portion 41, with the distal end having an arc shape corresponding to the inner circumferential surface of the cylindrical portion 41.
In the embodiment described above, the recess portions 23 and the catch portions 43 are provided at two different positions in the length direction of the electrical wires 20. However, no such limitation is intended. For example, the recess portions 23 and the catch portions 43 may be provided at only one position in the length direction of the electrical wires or may be provided at three or more positions.
In the embodiment described above, the recess portion 23 is formed from the outer circumferential surface of the electrical wire 20 to the core wire 21. However, no such limitation is intended, and the recess portion 23 may not be formed to the core wire 21. In other words, the insulating cover 22 may be formed thinly only at the recess portion 23, and the core wire 21 may not be exposed to the outside even at the portion corresponding to the recess portion 23.
In the embodiment described above, the catch portion 43 is formed to a position where it comes into contact with the outer circumferential surface of the core wire 21 when the catch portion 43 is fitted into the recess portion 23. However, no such limitation is intended, and the catch portion 43 may not be formed to a position where it comes into contact with the outer circumferential surface of the core wire 21.
In the embodiment described above, the holder 40 includes the pair of catch portions 43 located opposite one another in the radial direction of the holder 40, and the pair of catch portions 43 are configured to sandwich two electrical wires 20 in the direction the two electrical wires 20 are arranged. However, no such limitation is intended. For example, the pair of catch portions 43 may not be located opposite on another in the radial direction of the cylindrical portion 41 of the holder 40. Also, for example, the electrical wires 20 may be individually sandwiched by the catch portions 43.
In the embodiment described above, the wire harness 10 includes two electrical wires 20. However, no such limitation is intended, and one or three or more electrical wires may be included. Also, the number of the catch portions 43 provided in the circumferential direction of the holder 40 may be changed.
In the embodiment, the pipe 30 is formed as a perfect circle cylinder. However, no such limitation is intended, and the shape may be a rectangular prism-like shape, an elliptical shape, or the like, for example. Also, depending on the shape of the pipe 30, the shape of the cylindrical portion 41 of the holder 40 may be changed.
In the embodiment described above, the holder 40 is composed of separate components, the first component 44 and the second component 45. However, no such limitation is intended, and the first component 44 and the second component 45 may be joined by a thin hinge portion, for example.
In the embodiment described above, two of the through holes 31 and two of the fixing protrusion portions 41e are provided. However, no such limitation is intended, and only one of each may be provided or three or more of each may be provided, for example.

In the embodiment described above, the wire harness 10 electrically connects the inverter 11 and the high voltage battery 12. However, no such limitation is intended, and the wire harness 10 may electrically connect other electric devices.

What is claimed is:

1. A wire harness comprising:
an electrical wire including a core wire and an insulating cover that covers an outer circumference of the core wire;
a pipe that covers the electrical wire; and
a holder that holds the electrical wire and is fixed to an end of the pipe in a length direction, wherein:
the insulating cover includes a recess formed in an outer circumferential surface of the electrical wire, and
the holder includes a catch that restricts movement of the electrical wire in a length direction of the electrical wire relative to the holder by the catch fitting into the recess.

2. The wire harness according to claim 1, wherein
the catch also restricts movement of the electrical wire in a direction intersecting the length direction of the electrical wire relative to the holder when the catch is fitted into the recess.

3. The wire harness according to claim 1, wherein
the recess includes a plurality of recesses, and
the plurality of recesses is provided in the insulating cover at a plurality of different positions in the length direction of the electrical wire.

4. The wire harness according to claim 1, wherein
the recess is formed from the outer circumferential surface of the electrical wire to the core wire.

5. The wire harness according to claim 1, wherein
the electrical wire includes two electrical wires,
the catch includes a pair of catches located opposite one another in a radial direction of the holder, and
the pair of catches are configured to sandwich the two electrical wires in a direction the two electrical wires are arranged.
